(19) United States
(12) Patent Application Publication
(10) Pub. No.: US 2013/0309498 A1
(43) Pub. Date: Nov. 21, 2013

(54) Granulated Organopolysiloxane Products

(71) Applicants: Sung-Hsuen Chao, Seneffe (BE); Alain Hilberer, Recquignies (FR); Jean-Paul Lecomte, Bruxelles (Auderghem) (BE); Stephane Lecomte, Grandglise (BE); Marc Thibaut, Arquennes (BE)

(72) Inventors: Sung-Hsuen Chao, Seneffe (BE); Alain Hilberer, Recquignies (FR); Jean-Paul Lecomte, Bruxelles (Auderghem) (BE); Stephane Lecomte, Grandglise (BE); Marc Thibaut, Arquennes (BE)

(73) Assignee: Dow Corning Corporation, Midland, MI (US)

(21) Appl. No.: 13/991,670

(22) PCT Filed: Dec. 9, 2011
(86) PCT No.: PCT/EP2011/006224

§ 371 Date: Aug. 8, 2013

(30) Foreign Application Priority Data
Dec. 10, 2010 (GB) 1021170.4

(51) Int. Cl. C11D 17/06

(52) U.S. Cl. CPC C11D 17/06
USPC 428/402; 516/120; 510/515; 427/212

(57) ABSTRACT

A granulated product comprises a liquid organosilicon compound supported on a particulate carrier which is agglomerated into granules by a binder. A process for the production of a granulated product comprises depositing an organosilicon compound and a binder in a liquid state on a particulate carrier and subjecting the carrier thus treated to conditions in which the binder is solidified, thereby agglomerating carrier particles into granules. The particulate carrier is anhydrous sodium sulfate of mean particle size 1 to 40 μm.

This invention relates to granulated products, by which we mean particles agglomerated into larger particles called granules. In particular it relates to granulated products comprising a liquid organosilicon compound supported on a particulate carrier which is agglomerated into granules by a binder. Granulated organosilicon products, particularly organopolysiloxane products, have been used to add liquid organopolysiloxanes to a powdered product such as a laundry detergent powder. Granulated organopolysiloxane products have also been suggested for achieving controlled, sustained or delayed release of an organopolysiloxane in use.

U.S. Pat. No. 7,632,890 describes a foam control composition comprising a polydiorganosiloxane fluid and an additive composition of melting point 35 to 100° C. comprising a substantially non-polar organic material. The foam control composition is preferably supported on a particulate carrier. Suggested examples of carriers and/or supports are zeolites, for example Zeolite A or Zeolite X, other aluminosilicates or silicates, for example magnesium silicate, phosphates, for example powdered or granular sodium tripolyphosphate, sodium sulfate, sodium carbonate, for example anhydrous sodium carbonate or sodium carbonate monohydrate, sodium perborate, a cellulose derivative such as sodium carboxymethylcellulose, granulated starch, clay, sodium citrate, sodium acetate, sodium sesquicarbonate, sodium bicarbonate and native starch.

Granulated foam control compositions comprising a polydiorganosiloxane fluid foam control agent supported on a particulate carrier are also described for example in U.S. Pat. No. 7,407,991, U.S. Pat. No. 6,165,968, U.S. Pat. No. 4,894,177, U.S. Pat. No. 6,162,781, U.S. Pat. No. 5,456,855 and U.S. Pat. No. 5,073,384.

WO2007-028773 describes a solid composition for releasing active silicone ingredients comprising a cationic polymer, an active silicone ingredient and optionally a thickener and a carrier. Granular encapsulated compositions can be prepared by using the solid silicone-releasing composition as a component in a laundry detergent powder, tablet or bar. This is particularly of interest for the delivery of silicone ingredients in the rinse cycle of a laundry operation.

US2004-116316 describes an agglomeration process for the preparation of granules encapsulating a hydrophobic active material such as an organopolysiloxane. The active material and a molten binder which has a melting point above ambient temperature are sprayed onto water soluble carrier particles while agitating the particles. A liquid which interacts exothermically with the carrier particles is sprayed onto the carrier particles separately from and just before or simultaneously with the active material and binder, so that the heat generated by the interaction reduces the cooling rate of the binder during the agglomeration process. The liquid can be water when the carrier particles have a positive heat of hydration and/or solution by water.

Zeolites have been the most widely used carriers in granulated organopolysiloxane products. Zeolites have good stability but, being water insoluble, are present as a residue at the end of a washing process, which is a disadvantage particularly in dishwashers. There has also been a problem in ensuring release of the organopolysiloxane antifoam from the zeolite, especially in the early part of the washing cycle, which problem is addressed for example in U.S. Pat. No. 5,861,368. Zeolites are also relatively expensive. Maize starch has also been used but has the disadvantages noted above for zeolites. Sodium sulfate has been tried and has good physical stability and ageing properties but has not been able to hold sufficient liquid organopolysiloxane in the granules; generally less than 5% by weight organopolysiloxane is achieved.

A granulated product according to the invention comprises a liquid organosilicon compound supported on a particulate carrier which is agglomerated into granules by a binder, wherein the particulate carrier is anhydrous sodium sulfate of mean particle size 1 to 40 μm.

The invention includes a process for the production of a granules comprising depositing an organosilicon compound and a binder in a liquid state on a particulate carrier and subjecting the carrier thus treated to conditions in which the binder is solidified, thereby agglomerating carrier particles into granules comprising the organosilicon compound, wherein the particulate carrier is anhydrous sodium sulfate of mean particle size 1 to 40 μm.

Anhydrous sodium sulfate as commercially available generally has a mean particle size in the range 80 to 200 μm or even higher. We have found according to the invention that if the particle size of the sodium sulfate is reduced to a mean particle size in the range 1 to 40 μm a higher proportion of organosilicon compound can be included in the granules, so that sufficient organosilicon compound is present for the intended use without excess carrier and binder. In general at least 6% by weight organosilicon compound, and often 10 to 15% or even up to 20%, organosilicon compound can be included in the granules.

The organosilicon compound can be an organosilane or an organosiloxane, particularly an organopolysiloxane. For many uses the liquid organopolysiloxane is preferably a polydiorganosiloxane.

For antifoam granules, the liquid organopolysiloxane can for example be a polydimethylsiloxane (PDMS). Preferred liquid organopolysiloxanes are branched or higher viscosity (i.e. above 12,500 mm²/s at 25° C.) siloxanes such as PDMS, especially the branched siloxanes, as they show an improved ability to control foam in most aqueous surfactant solutions. Preferably at least 80% of all units in the branched organopolysiloxane, most preferably at least 90%, have the formula R₂SiO_{2/2}, where each group R represents an aliphatic or aromatic hydrocarbon group having up to 18 carbon atoms. It is most preferred that substantially all R groups are methyl or phenyl groups, especially methyl groups. The branched organopolysiloxane also contains units of the formula RSiO_{3/2} or SiO_{4/2}. These other units may be present as individual units in the siloxane chains, or they may be present as little clusters, from which a number of siloxane chains extend. Preferred branching units include small three-dimensional siloxane resin particles which may have a number of pending siloxane polymer units. Thus a very loose network is formed of polyorganosiloxane chains giving a fluid branched organopolysiloxane. Branched organopolysiloxanes and methods of making them are described for example in EP-A-217501, U.S. Pat. No. 4,639,489 and U.S. Pat. No. 5,668,101.

Alternative branched liquid organopolysiloxanes suitable for use in antifoam granules are described in WO 2007/137948. These branched or cross-linked organopolysiloxane materials are made by mixing a finely divided filler, whose surface is hydrophobic, with two polyorganosiloxanes capable of addition reaction with each other by hydrosilylation. Usually one of the polyorganosiloxanes conatins Si—H groups and the other polyorganosiloxane contains ethylenically unsaturated groups. One of the polyorganosiloxanes has at least three reactive substituents reactive by hydrosilylation and the other polyorganosiloxane has on average at least two substituents reactive by hydrosilylation. After the two polyorganosiloxanes capable of hydrosilylation are mixed with the finely divided filler, the polyorganosiloxanes are reacted in the presence of a hydrosilylation catalyst, generally a transition metal catalyst such as a platinum group metal catalyst.

Further alternative preferred polydiorganosiloxane fluids suitable for use in antifoam granules are polysiloxanes comprising at least 10% diorganosiloxane units of the formula

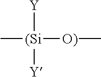

and up to 90% diorganosiloxane units of the formula

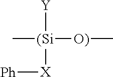

wherein X denotes a divalent aliphatic organic group bonded to silicon through a carbon atom; Ph denotes an aromatic group; Y denotes an alkyl group having 1 to 4 carbon atoms; and Y′ denotes an aliphatic hydrocarbon group having 1 to 24 carbon atoms, as described in EP1075864. These polysiloxanes are very effective in foam control, although they are more expensive than branched PDMS. The diorganosiloxane units containing a —X-Ph group preferably comprise 5 to 60% of the diorganosiloxane units in the fluid. The group X is preferably a divalent alkylene group having from 2 to 10 carbon atoms, most preferably 2 to 4 carbon atoms, but can alternatively contain an ether linkage between two alkylene groups or between an alkylene group and -Ph, or can contain an ester linkage. Ph is most preferably a phenyl group, but may be substituted for example by one or more methyl, methoxy, hydroxy or chloro group, or two substituents on the Ph group may together form a divalent alkylene group, or may together form an aromatic ring, resulting in conjunction with the Ph group in e.g. a naphthalene group. A particularly preferred X-Ph group is 2-phenylpropyl —CH₂—CH(CH₃)—C₆H₅. The group Y is preferably methyl but can be ethyl, propyl or butyl. The group Y′ preferably has 1 to 18, most preferably 2 to 16, carbon atoms, for example ethyl, methyl, propyl, isobutyl or hexyl. Mixtures of alkyl groups Y′ can be used, for example ethyl and methyl, or a mixture of dodecyl and tetradecyl. Other groups may be present, for example haloalkyl groups such as chloropropyl, acyloxyalkyl or alkoxyalkyl groups or aromatic groups such as phenyl bonded direct to Si.

The polysiloxane fluid (A)(i) containing —X-Ph groups may be a substantially linear siloxane polymer or may have some branching, for example branching in the siloxane chain by the presence of some tri-functional siloxane units, or branching by a multivalent, e.g. divalent or trivalent, organic or silicon-organic moiety linking polymer chains, as described in EP-A-1075684.

Further alternative preferred polydiorganosiloxane fluids suitable for use in antifoam granules are polysiloxanes comprising 50-100% diorganosiloxane units of the formula

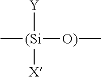

and optionally up to 50% diorganosiloxane units of the formula

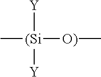

wherein Y denotes an alkyl group having 1 to 4 carbon atoms and X′ denotes an alkyl group having 6 to 18 carbon atoms. The groups Y in such a polydiorganosiloxane are preferably methyl or ethyl. The alkyl group X′ may preferably have from 6 to 12 or 14 carbon atoms, for example octyl, hexyl, heptyl, decyl, or dodecyl, or a mixture of dodecyl and tetradecyl.

It is preferred that the number of siloxane units (DP or degree of polymerisation) in the average molecule of a liquid polysiloxane containing —X-Ph or —Z groups is at least 5, more preferably from 10 to 5000. Particularly preferred are polysiloxanes with a DP of from 20 to 1000, more preferably 20 to 200. The end groups of the polysiloxane can be any of those conventionally present in siloxanes, for example trimethylsilyl end groups.

The liquid organopolysiloxane may alternatively be a polydiorganosiloxane having a fabric softening effect. The liquid organopolysiloxanes which provide softness to textile fabrics are preferably selected from substantially linear polydiorganosiloxane materials, which can be end-blocked with trialkylsilyl units, dialkylarylsilyl units, or dialkylsilanol units. The polydiorganosiloxanes may be unsubstituted, or may be substituted with amino functionality, amido functionality, or polyoxyalkylene functionality and may have amino or amido functionality and polyoxyalkylene functionality in the same polymer. The unsubstituted polyorganosiloxanes are polydihydrocarbylsiloxanes having siloxane units of the general formula RₐSiO_{4-a/2} where R denotes a hydrocarbon group, preferably having from 1 to 12 carbon atoms, preferably an alkyl, aryl or alkenyl group, most preferably an alkyl group having from 1 to 6 carbon atoms, most preferably methyl and a is an integer with a value from 0 to 3, but with an average value for the polymer of from 1.6 to 2.4, preferably 1.9 to 2.2. The unsubstituted polyorganosiloxane can for example be PDMS. These preferred polyorganosiloxanes are substantially linear materials with end-groups of the general formula R′R₂SiO_{1/2} where R′ is a group R or hydroxyl.

The polyorganosiloxanes substituted with amine, amido or polyoxyalkylene functionality have additionally siloxane units of the general formula R_{b}R′cSiO_{4-b-c/2}, where R is as defined above, R′ is a functional group, selected from an amine containing substituent, an amido containing substituent and a polyoxyalkylene containing substituent, b is an integer with a value of from 0 to 2, c is an integer with a value of 1, 2 or 3, b+c having a value of from 1 to 3, preferably with an average of from 1.6 to 2.4, more preferably 1.9 to 2.2. R′ groups with amine functionality are preferably selected from aminoalkyl groups. Suitable aminoalkyl groups have the formula R¹—(NH-A′)_{q}—NH-A- wherein A and A′ are each independently a linear or branched alkylene group having 1 to 6 carbon atoms and optionally containing an ether linkage; q=0 to 4; and R¹ is hydrogen or an alkyl or hydroxyalkyl group having 1 to 4 carbon atoms. Examples of preferred aminoalkyl groups include —(CH₂)₃NH₂, —(CH₂)₄NH₂, —(CH₂)₃NH(CH₂)₂NH₂, —CH₂CH(CH₃)CH₂NH(CH₂)₂NH₂, —(CH₂)₃NHCH₂CH₂NH(CH₂)₂NH₂, —CH₂CH(CH₃)CH₂NH(CH₂)SNH₂, —(CH₂)₃NH(CH₂)₄NH₂ and —(CH₂)₃—O—(CH₂)₂NH₂. Amido containing substituents R′ are provided for example by the group ═NC(O)(CHR²)ₙOH linked to the silicon atom through a divalent linkage R*. Preferably R² represents a hydrogen atom and n has the value 3, 4, 5 or 6. Preferred materials are those wherein R* represents a divalent hydrocarbon group or a group R³(NR⁴R³)ₛ wherein R³ represents a divalent hydrocarbon group, R⁴ represents a hydrogen atom, an alkyl group having 1 to 20 carbon atoms, an alkenyl group or an aryl group, or a group X, X represents the group CO(CHR⁵) OH, wherein R⁵ represents a hydrogen atom or an alkyl group and s has a value in the range 0 to 4, more preferably 1 or 2. Where the functionality is polyoxyalkylene, the substituent will have the general formula —R³(OC₂H₄ₜ(OC₃H₆), where R³ is as defined above, and t has a value of from 1 to 50, preferably 3 to 10 and u has a value of from 0 to 50, preferably 0 to 8.

The organosilicon compound can alternatively be a siloxane copolymer, for example a siloxane polyether copolymer. Siloxane polyether copolymers generally have surfactant properties and are useful for example as wetting agents. The siloxane polyether copolymer can for example be a silicone polyether block copolymer comprising at least one polydiorganosiloxane, for example polydimethylsiloxane block and at least one polyether, for example polyoxyethylene, block. Examples of silicone polyethers include Dow Corning DC193 silicone polyether (a PDMS polyoxyethylene copolymer of viscosity 335 cSt) and Dow Corning Q2-5247 silicone polyether (a PDMS polyoxyethylene/polyoxypropylene copolymer of viscosity 2305 cSt). The siloxane polyether copolymer can alternatively comprise a short chain polysiloxane having for example 2 to 6 siloxane units to which polyether chains are grafted; such siloxane polyether graft copolymers are known as ‘superwetters’. An example of a superwetter is an ethoxylated 3-hydroxypropylheptamethyltrisiloxanesuch as that sold by Dow Corning under the Trade Mark ‘Sylgard 309’. Granulated wetting agents are useful in agriculture for ease and control of application.

The organosilicon compound can alternatively be a hydrophobing agent, that is an organosilicon material added to a material to make it more hydrophobic. Organosilanes and organopolysiloxanes are both useful for this purpose. Granules comprising hydrophobing organosilanes and/or organopolysiloxanes can for example be used in construction materials such as gypsum and plasterboard.

Examples of organosilanes useful as hydrophobing agents include dialkoxysilanes and trialkoxysilanes, or a mixture of these with each other or with an organopolysiloxane. The dialkoxysilane generally has the formula Z₂Si(OZ′)₂ and the trialkoxysilane generally has the formula ZSi(OZ′)₃ in which Z in each formula represents an alkyl, substituted alkyl, aryl or substituted aryl group having 1 to 20 carbon atoms and each Z′ represents an alkyl group having 1 to 6 carbon atoms. The group Z can for example be substituted by a halogen, particularly fluoro, group, an amino group or an epoxy group, or an alkyl group can be substituted by a phenyl group or a phenyl group can be substituted by an alkyl group. Preferred silanes include those in which Z represents an alkyl group having 6 to 18 carbon atoms and each Z′ represents an alkyl group having 1 to 4, particularly 1 or 2, carbon atoms, for example n-octyl trimethoxysilane, 2-ethylhexyl triethoxysilane or n-octyl triethoxysilane.

Examples of organopolysiloxanes which can be used as hydrophobing agents include PDMS and organopolysiloxanes comprising methylalkylsiloxane units in which the said alkyl group contains 2-20 carbon atoms. Such methylalkylsiloxane polymers, particularly those in which the said alkyl group contains 6-20 carbon atoms, may confer even higher water resistance than PDMS. One example of such a polymer is a dimethyl methyloctyl siloxane copolymer sold by Dow Corning under the product name 16-846. The total number of siloxane units is preferably such that the organopolysiloxane has a viscosity of 1 to 60,000, preferably 1 to 5,000 mm²/s at 25° C. Some of the alkyl groups of the organopolysiloxane can contain a trialkoxysilyl substituent. An example of such a polyorganosiloxane is the dimethyl methyloctyl methyl(triethoxysilyl)propyl siloxane copolymer sold by Dow Corning under the product name 16-606. Blends of organopolysiloxanes can be used, for example a blend of a methylalkylsiloxane polymer with a linear PDMS.

A blend of an organopolysiloxane and an organosilane, particularly a trialkoxysilane can form a highly advantageous hydrophobing additive conferring excellent hydrophobic properties both instantaneously and over time. An organopolysiloxane such as linear PDMS or the dimethyl methyloctyl methyl(triethoxysilyl)propyl siloxane copolymer ‘Dow Corning 16-606’ can be blended with a long chain alkyl trialkoxysilane such as n-octyl triethoxysilane.

The organosilicon compound can alternatively be a quaternary ammonium organosilane having antimicrobial properties. The quaternary ammonium organosilane generally is of the formula

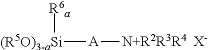

where each R⁵ represents an alkyl group having 1 to 4 carbon atoms; R⁶ represents an alkyl group having 1 to 4 carbon atoms; a is 0, 1 or 2; A represents an alkylene group having 1 to 4 carbon atoms; each of the groups R², R³ and R⁴ represents an alkyl or hydroxyalkyl group having 1 to 18 carbon atoms or an aralkyl radical having 7 to 10 carbon atoms; and X represents an anion. Two of the groups R², R³ and R⁴ may be joined to form a heterocyclic ring, or the N+R²R³R⁴ moiety can be a pyridinium group. The quaternary ammonium organosilane can for example be octadecyldimethyltrimethoxysilylpropyl ammonium chloride

(CH₃O)₃Si(CH₂)₃N⁺(CH₃)₂C₁₈H₃₇Cl⁻

sold under the Trade Mark/EGIS Microbe Shield®—AEM 5772. The antimicrobial granules containing such quaternary ammonium organosilanes can be used in eliminating and preventing microbiological contamination and deterioration of surfaces of buildings and walls, and preventing alteration and biodeterioration of various construction materials, particularly gypsum products such as plaster. The antimicrobial granules can also be used as preservative agents for emulsions, dispersions or solutions in a medium where biological growth can be observed, in cosmetics, disinfectants, detergents, textiles, pulp and paper, packaging, wood preservation, water treatment, water transportation, food, oil and gas, and coatings, or in preventing biodeterioration of substrates such as fabrics.

Where the granulated product is a foam control agent (antifoam), the liquid organopolysiloxane generally has a hydrophobic filler dispersed therein. Hydrophobic fillers for foam control agents are well known and are particulate materials which are solid at 100° C., such as silica, preferably with a surface area as measured by BET measurement of at least 50 m²/g, titania, ground quartz, alumina, an aluminosilicate, zinc oxide, magnesium oxide, a salt of an aliphatic carboxylic acids; a reaction product of an isocyanate with an amine, e.g. cyclohexylamine, or an alkyl amide such as ethylenebisstearamide or methylenebisstearamide. Mixtures of two or more of these can be used.

Some of the fillers mentioned above are not hydrophobic in nature, but can be used if made hydrophobic. This can be done either in situ (i.e. when dispersed in the polysiloxane fluid), or by pre-treatment of the filler prior to mixing with the polysiloxane fluid. A preferred filler is silica which is made hydrophobic. Preferred silica materials are those which are prepared by heating, e.g. fumed silica, or precipitation. The silica filler may for example have an average particle size of 0.5 to 50 μm, preferably 2 to 30 and most preferably 5 to 25 μm. It can be made hydrophobic by treatment with a fatty acid, but is preferably made hydrophobic by the use of methyl substituted organosilicon materials such as dimethylsiloxane polymers which are end-blocked with silanol or silicon-bonded alkoxy groups, hexamethyldisilazane, hexamethyldisiloxane or organosilicon resins containing (CH₃)₃SiO_{1/2} groups and silanol groups. Hydrophobing is generally carried out at a temperature of at least 100° C. Mixtures of fillers can be used, for example a highly hydrophobic silica filler such as that sold under the Trade Mark ‘Sipemat D10’ can be used together with a partially hydrophobic silica such as that sold under the Trade Mark ‘Aerosil R972’.

The amount of hydrophobic filler in such a foam control composition is preferably 0.5-50% by weight based on the liquid organopolysiloxane fluid, more preferably from 1 up to 10 or 15% and most preferably 2 to 8% by weight.

Where the granulated product is a foam control agent, the liquid organopolysiloxane can optionally also have an organosilicon resin dispersed therein. The organosilicon resin is generally a non-linear siloxane resin and preferably consists of siloxane units of the formula R*ₐSiO_{4-a/2} wherein R* denotes a hydroxyl, hydrocarbon or hydrocarbonoxy group, and wherein a has an average value of from 0.5 to 2.4. It preferably consists of monovalent trihydrocarbonsiloxy (M) groups of the formula R″3SiO1/2 and tetrafunctional (Q) groups SiO4/2 wherein R″ denotes a monovalent hydrocarbon group. The number ratio of M groups to Q groups is preferably in the range 0.4:1 to 2.5:1 (equivalent to a value of a in the formula R*ₐSiO_{4-a/2} of 0.86 to 2.15), more preferably 0.4:1 to 1.1:1 and most preferably 0.5:1 to 0.8:1 (equivalent to a=1.0 to a=1.33). The organosilicon resin is preferably a solid at room temperature. The molecular weight of the resin can be increased by condensation, for example by heating in the presence of a base. A resin comprising M groups, trivalent R″SiO_{3/2}(T) units and Q units can alternatively be used, or up to 20% of units in the organosilicon resin can be divalent units R″2SiO_{2/2}. The group R″ is preferably an alkyl group having 1 to 6 carbon atoms, for example methyl or ethyl, or can be phenyl. It is particularly preferred that at least 80%, most preferably substantially all, R″ groups present are methyl groups.

The organosilicon resin is preferably present in the antifoam at 1-50% by weight based on the liquid organopolysiloxane, particularly 2-30% and most preferably 4-15%. The organosilicon resin may be soluble or insoluble in the organopolysiloxane. If the resin is insoluble in the organopolysiloxane, the average particle size of the resin may for example be from 0.5 to 40 μm, preferably 2 to 5 μm.

The particulate carrier for the granulated product is anhydrous sodium sulfate of mean particle size 1 to 40 μm. Sodium sulfate is produced either from natural brine or as a by-product of a chemical process such as the manufacture of rayon by the viscose process or the manufacture of sodium dichromate or hydrochloric acid. When produced from brine or from the viscose rayon process, the sodium sulfate is generally first crystallised and recovered as Glauber's salt (hydrated sodium sulfate). Glauber's salt can be converted to anhydrous sodium sulfate by melting or complete dehydration. As stated above, anhydrous sodium sulfate as commercially available generally has a mean particle size in the range 80 to 200 μm or even higher. We have found it necessary to grind the sodium sulfate to a mean particle size of below 40 μm to produce particles which can adsorb sufficient liquid organopolysiloxane to form granules having an effective level of the organopolysiloxane. Preferably the sodium sulfate is ground to a particle size below 35 μm, more preferably below 30 μm. Although the sodium sulfate of mean particle size 1 to 40 μm can be produced by other methods, for example by sieving sodium sulfate having a wide range of particle size, we believe that sodium sulfate that has been ground may be more effective.

Suitable equipment that can be used to grind the sodium sulfate includes ball-mills (such as those from Metso or Alpine), jet mills (for example those from Netsch or Alpine), pin mills (e.g. an Alpine pin mill), air classifying mills (for example the Mikro ACM or Netsch air classifying mill), attrition mills (for example the Alpine AFS or the Attrimill from Poittemill) or roller mills (such as the table roller mills available from Alpine or Poittemill).

The mean particle size of the sodium sulfate is measured by the method called ‘laser diffraction’ using the ISO procedure described in ISO 13320:2009. The equipment used is a Sympatec Helos KF (trade mark) fitted with a Rodos/M dry disperser. The pressure applied to disperse the granules through the laser is 2 bars and the lens used for the measurement is the lens R3. The full method is:
Put around 50 g of a representative sample in the feeder.
Start the measurement using the lens R3 (range of particles=0.9 μm-175 μm).
The equipment is automatically injecting the powder with a pressured system (RODOS) through the laser beam.
   The diffracted beam is collected on a sensor, and a particle size distribution is generated by correlation (see ISO 13320:2009 for theory).

The mean particle size of the sodium sulfate is preferably in the range 1 to 25 μm, particularly from 5 μm up to 15 or 20 μm. At this level 10 to 14% by weight organopolysiloxane or other organosilicon compound can be included in the granules, which generally means that an effective level of liquid organopolysiloxane can be included in a composition such as a detergent composition or a fabric softening composition without using an unacceptably high content of granules. We have found that there is usually no added benefit by reducing the particle size of the sodium sulfate below 5 μm. The sodium sulfate particles generally form from 60% by weight to 85 or 90% by weight of the granulated product

The binder is a material which aids in binding the liquid organosilicon component to the particulate carrier. The binder can be applied to the sodium sulfate carrier as a liquid binding medium and which can be solidified to a solid which binds carrier particles together. The binder is preferably a material which at room temperature, i.e. from 20 to 25° C., has a solid consistency. The liquid organosilicon compound is generally dispersible in the liqiod binding medium. The liquid binding medium may or may not be a solvent for the sodium sulfate carrier; if it is a solvent it is used in an amount and for a time less than that required to fully dissolve the sodium sulfate carrier. The liquid binding medium can for example be a solution which is solidifed by drying or a melt which is solidifed by cooling.

In one embodiment of the invention the binder comprises a waxy material of melting point 35 to 100° C. Such a binder can be applied in a molten state to the sodium sulfate carrier and can be solidifed by cooling to agglomerate the carrier particles.

The waxy material of melting point of 35 to 100° C. is preferably miscible with the liquid organosilicon compound. By ‘miscible’, we mean that materials in the liquid phase (i.e., molten if necessary) mixed in the proportions in which they are present in the foam control composition do not show phase separation. This can be judged by the clarity of the liquid mixture in the absence of any filler or resin. If the liquids are miscible the mixture is clear and remains as one phase. If the liquids are immiscible the mixture is opaque and separates into two phases upon standing.

The waxy material of melting point of 35 to 100° C. can for example comprise a polyol ester which is a polyol partially or fully esterified by carboxylate groups each having 7 to 36 carbon atoms. The polyol ester is preferably a glycerol ester or an ester of a higher polyol such as pentaerythritol or sorbitol. The polyol ester is preferably a monocarboxylate or polycarboxylate (for example a dicarboxylate, tricarboxylate or tetracarboxylate) in which the carboxylate groups each having 18 to 22 carbon atoms. Such polyol carboxylates tend to have a melting point at least 45° C. The polyol ester can be a diester of a glycol such as ethylene glycol or propylene glycol, preferably with a carboxylic acid having at least 14 carbon atoms, more preferably having 18 to 22 carbon atoms, for example ethylene glycol distearate. Examples of preferred glycerol esters include glycerol tristearate and glycerol esters of saturated carboxylic acids having 20 or 22 carbon atoms such as the material of melting point 54° C. sold under the Trade Mark ‘Synchrowax HRC’, believed to be mainly triglyceride of C₂₂ fatty acid with some C₂₀ and C₁₈ chains. Alternative suitable polyol esters are esters of pentaerythritol such as pentaerythritol tetrabehenate and pentaerythritol tetrastearate.

The polyol ester can contain fatty acids of different chain length, which is common in natural products. The organic additive (B) can be a mixture of polyol esters, for example a mixture of esters containing different carboxylate groups such as glycerol tripalmitate and glycerol tristearate, or glycerol tristearate and Synchrowax HRC, or ethylene glycol distearate and Synchrowax HRC.

The waxy material of melting point 35 to 100° C. can also comprise a more polar polyol ester. Preferred polar polyol esters include partially esterified polyols including monoesters or diesters of glycerol with a carboxylic acid having 8 to 30 carbon atoms, for example glycerol monostearate, glycerol monolaurate, glycerol distearate or glycerol monobehanate. Mixtures of monoesters and diesters of glycerol can be used. Partial esters of other polyols are also useful, for example propylene glycol monopalmitate, sorbitan monostearate or ethylene glycol monostearate.

The waxy material of melting point 35 to 100° C. can comprise an alcohol such as a long chain primary, secondary or tertiary alcohol including fatty alcohols, ethoxylated fatty alcohols, ethoxylated fatty acids, ethoxylated alkyl phenols and partial esters of polyols. The alcohols preferably contain 8 to 32 carbon atoms such as lauryl alcohol, a branched C32 alcohol sold under the Trade Mark Isofol32 believed to comprise 2-tetradecyloctadecanol, a branched C12 alcohol sold under the Trade Mark Isofol 12 believed to comprise 2-butyloctanol, a branched C20 alcohol sold under the Trade Mark Isofol 20 believed to comprise 2-octyldodecanol, stearyl alcohol, behenyl alcohol or oleyl alcohol. The ethoxylated fatty alcohols preferably contain 1 to 10 oxyethylene units and the alkyl group of the fatty alcohol preferably contains 14 to 24 carbon atoms, for example “Volpo S2” (Trade Mark) which is an ethoxylated stearyl alcohol containing an average of 2 oxyethylene units per molecule, or “Volpo CS5” (Trade Mark) which is an ethoxylated mixture of hexadecyl and stearyl alcohols having an average of 5 oxyethylene units per molecule. or a hydrogenated tallow alcohol ethoxylate. The ethoxylated fatty acids preferably contain 1 to 10 oxyethylene units and the alkyl group of the fatty acid preferably contains 14 to 24 carbon atoms. The ethoxylated alkyl phenols preferably contain 1 to 10 oxyethylene units and the alkyl group attached to the phenol nucleus preferably contains 6 to 12 carbon atoms, for example ethoxylated octylphenol or ethoxylated nonylphenol.

The waxy material of melting point 35 to 100° C. can comprise an alkyl phenol having one or more alkyl substituent and preferably containing a total of 6 to 12 carbon atoms in the alkyl substituent or substituents attached to the phenol nucleus, for example octylphenol or nonylphenol or di(t-butyl)phenol.

The waxy material of melting point 35 to 100° C. can comprise a material containing unesterified —COOH groups, amide groups or amino groups. Examples of waxy materials containing —COOH groups are fatty acids having 8 to 36 carbon atoms, for example stearic acid, palmitic acid, behenic acid, oleic acid or 12-hydroxystearic acid. Mixtures of fatty acids can be used. Examples of waxy materials containing amide groups are monoamides of fatty acids having 12 to 36 carbon atoms, for example stearamide, erucamide, oleamide or behenamide. Examples of waxy materials containing amino groups are alkyl amines having 8 to 30 carbon atoms such as 1-octylamine, 1-dodecylamine or stearylamine.

The waxy material of melting point 35 to 100° C. can alternatively be a hydrocarbon wax, for example it can comprise at least one paraffin wax, optionally blended with microcrystalline wax, for example the wax sold under the Trade Mark ‘Cerozo’.

In another embodiment of the invention the binder can comprise a water-soluble or water-dispersible polymer, preferably a film-forming polymer. Such a binder can be applied as an aqueous solution or emulsion to the sodium sulfate carrier and can be solidifed by drying to agglomerate the carrier.

A water-soluble or water-dispersible polymer binder can for example be an anionic polymer. Examples of water-soluble anionic polymers include polycarboxylates, for example polyacrylic acid or a partial sodium salt thereof or a copolymer of acrylic acid, for example a copolymer with maleic anhydride, and carboxymethyl cellulose.

A water-soluble or water-dispersible polymer binder can alternatively be a cationic polymer. The cationic polymer has a higher water solubility at neutral pH of 7 than at a basic pH of 9-11. The cationic polymer is preferably a homopolymer or copolymer prepared from monoethylenically unsaturated monomers, particularly acrylic or methacrylic monomers. Some examples of monomers that can be used to prepare the cationic homopolymer or copolymer include dialkylaminoalkyl acrylates, dialkylaminoalkyl methacrylates, dialkylaminoalkyl acrylamides, dialkylaminoalkylalkyl acrylamides, dialkylaminoalkyl methacrylamides, dialkylaminoalkylalkyl methacrylamides, in which the alkyl groups are alkyl groups containing 1-4 carbon atoms, vinylpyridine, vinylimidazole. For water-soluble polymers the monomers may be partially quaternised, fully quaternised, or salified, by an acid, a quaternising agent, benzyl chloride, methyl chloride, an alkyl chloride, an aryl chlorides, or dimethylsulfate. As used herein, salified refers to the salt formed by the acid-base reaction between the amino and an acid. The cationic polymer can contain comonomers, for example acrylamide, methacrylamide and derivatives thereof.

A water-soluble or water-dispersible polymer binder can alternatively be a nonionic polymer, for example polyvinylalcohol or methyl cellulose.

Examples of suitable water-insoluble but water-dispersible (emulsifiable) binder materials include polymers such as polyvinyl acetate, vinyl acetate ethylene copolymers and acrylate ester polymers. Blends of binder material as described above can be used, for example a blend of a water-soluble binder polymer such as polyvinyl alcohol with a water-insoluble binder polymer such as polyvinyl acetate.

A combination of binders can be used, for example the granulated product can comprise a waxy material binder of melting point 35 to 100° C. and a water-soluble or water-dispersible polymer binder.

The binder is preferably present in the granulated product at 10-200% by weight based on the liquid organosilicon compound, most preferably at 20 up to 100 or 120% based on the liquid organosilicon compound.

The liquid organosilicon compound is preferably mixed with the binder and the mixture is deposited on the carrier particles in liquid form. Alternatively the liquid organosilicon compound and the binder in liquid form can be deposited simultaneously on the carrier particles. Where the organosilicon compound is an organopolysiloxane foam control composition, the hydrophobic filler and the organosilicone resin if used are preferably incorporated in the liquid organopolysiloxane before the organopolysiloxane is mixed with the binder.

Where the binder is a waxy material of melting point 35 to 100° C., a mixture of the liquid organosilicon compound and the waxy material is preferably deposited on the carrier particles at a temperature at which the waxy material is molten, for example a temperature in the range 40-100° C. As the mixture cools on the carrier particles, it solidifies to a structure in which the waxy material binds carrier particles together to form a granulated product.

Where the binder is a water-soluble or water-dispersible polymer, the binder can be deposited on the carrier particles as an aqueous solution or emulsion. The liquid organosilicon compound can be mixed with the binder, for example it can be emulsified in the aqueous liquid composition, or the liquid organosilicon compound and the aqueous solution or emulsion of the binder can be deposited simultaneously on the carrier particles. The solution or emulsion of the binder is solidified by drying the treated carrier, for example in a stream of gas such as air, which may be heated. As the polymer binder dries, it binds carrier particles together to form a granulated product.

The liquid organosilicon component and a water-insoluble but water-dispersible binder polymer can be applied to the particulate carrier from aqueous emulsion. The emulsifier present can for example be a nonionic, anionic, cationic or amphoteric emulsifier. Examples of non-ionic emulsifiers include polyvinyl alcohol, ethylene oxide propylene oxide block copolymers, alkyl or alkaryl polyethoxylates in which the alkyl group has 8 to 18 carbon atoms, alkyl polyglycosides or long chain fatty acids or alcohols. Some water-soluble polymers such as polyvinyl alcohol can thus act as both binder polymer and emulsifier. In some preferred emulsions polyvinyl alcohol acts as emulsifier and also as part of the binder polymer together with a water-insoluble polymer such as polyvinyl acetate. Examples of anionic surfactants include alkali metal and ammonium salts of fatty acids having 12 to 18 carbon atoms, alkaryl sulfonates or sulfates and long chain alkyl sulfonates or sulfates. Examples of cationic surfactants include quaternary ammonium salts containing at least one long chain alkyl group having 8 to 20 carbon atoms.

Where the binder comprises a waxy material and a solution or emulsion of a polymer, a mixture of the liquid organosilicon compound and the waxy material is preferably deposited on the carrier particles at a temperature at which the waxy material is molten. The mixture of the liquid organosilicon compound and the waxy material can be emulsified in the aqueous liquid solution or emulsion comprising the polymer binder. More preferably, the mixture of the liquid organosilicon compound and the waxy material, and the aqueous solution or emulsion of the binder can be deposited simultaneously on the carrier particles. Both the waxy material binder and the dissolved or dispersed polymer binder can be solidifed by drying the treated particulate carrier in a gas flow cool enough to solidify the waxy material.

The product is preferably agglomerated into granules by a process in which the liquid organosilicon compound and the liquid binding medium are sprayed onto the carrier particles while agitating the particles. The particles can for example be agitated in a high shear mixer through which the particles pass continuously.

One type of suitable mixer is a vertical, continuous high shear mixer in which the liquid organosilicon compound and the binder in a liquid state are sprayed onto the particles. One example of such a mixer is a Flexomix mixer supplied by Hosokawa Schugi.

Alternative suitable mixers include horizontal high shear mixers, in which an annular layer of the powder-liquid mixture is formed in the mixing chamber, with a residence time of a few seconds up to about 2 minutes. Examples of this family of machines are pin mixers (e.g. TAG series supplied by LB, RM-type machines from Rubberg-Mischtechnik or pin mixers supplied by Lodige), and paddle mixers (e.g. CB series supplied by Lodige, Corimix (Trade Mark) from Lodige, or Conax (Trade Mark) machines from Ruberg Mischtechnik).

Other possible mixers which can be used in the process of the invention are Glatt granulators, ploughshare mixers, as sold for example by Lodige GmbH, twin counter-rotating paddle mixers, known as Forberg (Trade Mark)-type mixers, intensive mixers including a high shear mixing arm within a rotating cylindrical vessel, such as “Typ R” machines sold by Eirich, Zig-Zag (Trade Mark) mixers from Patterson-Kelley, and HEC (Trade Mark) machines sold by Niro.

Another possible agglomeration method is fluidized bed. Examples of fluid bed aggolmeration machines are Glatt fluidized bed and Aeromatic/Niro fluidized bed units. In fluidized bed, agglomeration take place by atomizing the liquid dispersion (solution, suspension or emulsion) onto the suspended bed of particles to make the granules.

The granules produced according to the invention generally have a mean particle diameter of at least 0.1 mm, preferably over 0.25 or 0.5 mm, up to a mean diameter of 1.2 or 1.5 or even 2 mm. We have found that granules according to the invention of this particle size, particularly 0.5 to 1 mm, have good flow properties and resistance to compaction.

The granulated product can conveniently be added to products which are in powder or other solid form. Organopolysiloxane foam control granules of the invention, for example, are typically added to detergent powders at 0.1 to 10% by weight, preferably 0.2 to 0.5 or 1.0%. Fabric softening granules can also be added to powder laundry detergents. The detergent compositions may for example be laundry detergents having high levels of anionic surfactants, e.g. sodium dodecyl benzene sulphonate. Foam control granules of the invention can also be incorporated in powder or tablet detergents designed for use in dishwashers. The water solubility of the sodium sulfate carrier is a particular advantage in dishwasher detergents, where any solid residue is to be avoided.

The granulated products of the invention are robust, are easily dispersed into powdered materials and have good bulk flow. Organopolysiloxane foam control granules of the invention, for example, are easily dispersed into detergent powders and do not separate on storage of the detergent powders. They thus achieve the ease of addition which is the advantage that granules have compared to use of organosilicon compound alone.

The invention is illustrated by the following Examples in which parts and percentages are by weight and viscosities are measured at 25° C.:

### EXAMPLE 1

Anhydrous sodium sulfate of mean particle size 200 μm was ground to a particle size (mean particle size by weight) of 10 μm.

6% by weight Sipernat (Trade mark) D10 treated precipitated silica and 1% R972 partially hydrophobic silica (both supplied by Evonik) were dispersed in 86.3% polydiorganosiloxane fluid having a degree of polymerisation of 65 and comprising 80 mole % methyl dodecyl siloxane groups, 20 mole % methyl 2-phenylpropyl (derived from [alpha]-methylstyrene) siloxane groups and 1 mole % divinyl crosslinking groups. 6.7% by weight of a 60% by weight solution of an organosiloxane resin having trimethyl siloxane units and SiO2 units in a M/Q ratio of 0.65/1 in octyl stearate (70% solid) was added. The mixture was homogenised through a high shear mixer to form a foam control agent FC1.

The foam control agent FC 1 was mixed with glyceryl monostearate at 60° C. in a ratio of 2:1. 207 g of the resulting liquid mixture was added gradually to 500 g sodium sulfate ground to a particle size 10 μm while mixing in a food mixer. Agglomerated granules with good flowability containing 19.5% silicone were produced. The bulk density of the resulting granules was 820 g/1

### EXAMPLE 2

139 g of the liquid mixture of FC1 and glyceryl monostearate prepared in Example 1 was mixed with 38.4 g of Sokalan CP5 20% aqueous solution. The resulting liquid mixture was added gradually to 500 g sodium sulfate ground to a particle size 10 μm while mixing in a food mixer. Agglomerated granules with excellent flowability and no cake strength containing 12.2% silicone were produced. The bulk density of the resulting granules was 832 g/l

### EXAMPLE 3

A liquid surfactant dispersion comprising 41.7% Dow Corning DC193 silicone polyether (a PDMS polyoxyethylene copolymer of viscosity 335 cSt), 36.1% Sokalan CP5 maleic acid acrylic acid copolymer 40% aqueous solution and 22.2% water was poured onto 207 g ground sodium sulfate of mean particle size 10 μm while the sodium sulfate was agitated in a mixer. Agglomerated granules of size about 1 mm were formed. 62.6 g of the liquid surfactant dispersion could be added without clumping of the granules into large lumps, giving granules of average silicone content 10.8% on a dry weight basis.

### EXAMPLE 4

A liquid surfactant dispersion comprising 42.55% Dow Corning Q2-5247 silicone polyether (a PDMS polyoxyethylene/polyoxypropylene copolymer of viscosity 2305 cSt), 36.35% Sokalan CP5 40% aqueous solution and 21.1% water was poured onto 204.3 g ground sodium sulfate of mean particle size 10 μm while the sodium sulfate was agitated in a mixer. Agglomerated granules of size about 1 mm were formed. 68.1 g of the liquid surfactant dispersion could be added without clumping of the granules into large lumps, giving granules of average silicone content 11.9% on a dry weight basis.

### EXAMPLE 5

16.5 g of Volpo T7/85 nonionic surfactant supplied by Croda were dissolved in 33 g water. Once homogeneous, 42.3 g of a substantially linear amino siloxane fluid having a viscosity of 1500 mm²/s and containing 0.4% by weight nitrogen in the form of monoamine groups was added while stirring to form a thick viscous emulsion. Once homogeneous, this thick phase was diluted down using 99 g of Sokalan PA25 PN 50% aqueous solution.

63 g of this emulsion was added to 200 g of sulfate of mean particle size 10 μm while the sodium sulfate was agitated in an agglomerator. The granules obtained were dried as a fluidised bed using hot air at 60° C. to remove water.

### EXAMPLE 6

50% ‘Sylgard 309’ silicone polyether surfactant superwetter, consisting essentially of 1,1,1,3,5,5,5-heptamethyl-3-(propyl(polyethoxylate)acetate)-trisiloxane, was mixed with 50% Sokalan CP5 40% aqueous solution. 60 g of this liquid solution was added to 200 g of sulfate of mean particle size 10 μm while the sodium sulfate was agitated in an agglomerator to form granules, giving granules containing 12.4% silicone.

### EXAMPLE 7

The foam control agent FC 1 was mixed with glyceryl monostearate at 60° C. in a ratio of 2:1. 207 g of the resulting liquid mixture was added gradually to 500 g sodium sulfate ground to a particle size 10 μm while mixing in a food mixer. agglomerated granules with good flowability containing 19.5% silicone were produced.

### EXAMPLE 8

A foam control agent FC2 comprising a branched polydimethylsiloxane of viscosity 31000 cSt and 5% hydrophobic silica was prepared according to the teaching of EP-A-217501. An emulsion was prepared from 100 g FC2, 100 g ‘Sokolan PA25’ 40% aqueous polyacrylic acid solution and 10 g dodecylbenzenesulfonic acid (DBSA), and was diluted with 30 g water. 127 g of the diluted emulsion was added gradually to 400 g sodium sulfate ground to a particle size 10 μm while mixing in a food mixer. Agglomerated granules with excellent flowability and no cake strength containing 14.8% silicone were produced. The bulk density of the granule was 810 g/l

### EXAMPLES 9 AND 10

40 parts of Sokalan CP5 40% aqueous solution were mixed with 6 parts of DBSA and 8.5 parts of water. Then 40 parts of foam control agent FC2 were dispersed in to give a cream-like emulsion liquid feed.

This liquid feed was poured under agitation onto sodium sulfate (300 g) of different particle sizes to form granules by agglomeration. The grades of sodium sulfate used were

Comparative Example C1—standard sodium sulfate of mean particle size by weight (×50) 195 μm supplied by Crimidesa
Example 8—sodium sulfate of mean particle size 13.5 μm produced by grinding the above standard sodium sulfate
Example 9—sodium sulfate of mean particle size 27 μm supplied by Crimidesa as ‘PO sulfate’
Comparative Example C2—sodium sulfate of mean particle size 401 μm supplied by Crimidesa as ‘granular sulfate’.

For each grade of sodium sulfate, the maximum amount of liquid feed was added while keeping the product as free flowing granules of granule particle size 0.4 to 1 mm. This maximum amount is shown in Table 1. The amount of silicone active (% by weight) in the granules produced using the maximum amount of liquid feed was calculated and is shown in Table 1

TABLE 1

| | Sulfate | Sulfate | Liquid | |
|---|---|---|---|---|
| | particle size | Amount | feed | Silicone |
| Example | x50 (μm) | (g) | (g) | active |
| 9 | 13.5 | 300.0 | 70.0 | 8.6% |
| 10 | 27 | 300.2 | 49.6 | 6.4% |
| C1 | 195 | 301.0 | 24.2 | 3.2% |
| C2 | 401 | 300.4 | 11.3 | 1.6% |

### EXAMPLES 11 AND 12 AND COMPARATIVE EXAMPLES C3 AND C4

45 parts of ethoxylated tallow alcohol (Lutensol AT80) and 15 parts of stearic acid (Radiacid 154) were heated under agitation until melted. Then 40 parts of foam control agent FC2 were dispersed in the melt while keeping the mixture above the melting temperature to form a molten liquid feed.

This molten liquid feed was poured under agitation onto the grades of sodium sulfate of different particle sizes described in Example 8 to form granules by agglomeration. For each grade of sodium sulfate, the maximum amount of liquid feed was added while keeping the product as free flowing granules of granule particle size 0.4 to 1 mm. This maximum amount, and the % by weight silicone active in the granules produced, are shown in Table 2

TABLE 2

| | Sulfate particle | Amount | Liquid | Silicon |
|---|---|---|---|---|
| Example | size x50 (μm) | (g) | feed 2 (g) | active |
| 11 | 13.5 | 314.0 | 116.8 | 11.0% |
| 12 | 27 | 301.3 | 84.5 | 8.7% |
| C3 | 195 | 306.3 | 28.2 | 3.3% |
| C4 | 401 | 300.2 | 13.0 | 1.6% |

1. A granulated product comprising a liquid organosilicon compound supported on a particulate carrier which is agglomerated into granules by a binder, wherein the particulate carrier is anhydrous sodium sulfate having a mean particle size of from 1 to 40 μm.

2. A granulated product according to claim 1 wherein the liquid organosilicon compound is an organopolysiloxane.

3. A granulated product according to claim 2 which is an antifoam, wherein the organopolysiloxane is a polydiorganosiloxane having a hydrophobic filler dispersed therein.

4. A granulated product according to claim 3, wherein the polydiorganosiloxane is a branched polydimethylsiloxane.

5. A granulated product according to claim 3, wherein the polydiorganosiloxane comprises at least 10% units of the formula 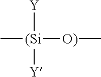
and up to 90% diorganosiloxane units of the formula 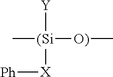
wherein X denotes a divalent aliphatic organic group bonded to silicon through a carbon atom; Ph denotes an aromatic group; Y denotes an alkyl group having from 1 to 4 carbon atoms; and Y′ denotes an aliphatic hydrocarbon group having from 1 to 24 carbon atoms.

6. A granulated product according to claim 3, wherein the polydiorganosiloxane comprises at least 10% units of the formula 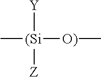
and optionally up to 50% diorganosiloxane units of the formula 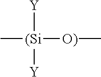
wherein Y denotes an alkyl group having from 1 to 4 carbon atoms and Z denotes an alkyl group having from 6 to 18 carbon atoms.

7. A granulated product according to claim 2, wherein the organopolysiloxane is a polydiorganosiloxane having a fabric softening effect.

8. A granulated product according to claim 7, wherein the polydiorganosiloxane contains aminoalkyl groups.

9. A granulated product according to claim 1, wherein the liquid organosilicon compound is a silicone polyether.

10. A granulated product according to claim 1, wherein the liquid organosilicon compound is a hydrophobic organosilane or organopolysiloxane.

11. A granulated product according to claim 1, wherein the binder comprises a waxy material having a melting point of from 35 to 100° C.

12. A granulated product according to claim 1, wherein the binder comprises a water-soluble or water-dispersible polymer.

13. A granulated product according to claim 1, wherein the sodium sulfate is grounded.

14. A granulated product according to claim 1, wherein the mean particle size of the sodium sulfate is from 1 to 25 μm.

15. A granulated product according to claim 1, wherein the mean particle size of the granules is from 0.1 to 1.5 mm.

16. A process for the production of granules comprising depositing an organosilicon compound and a binder in a liquid state on a particulate carrier and subjecting the treated carrier to conditions in which the binder is solidified, thereby agglomerating carrier particles into granules comprising the organosilicon compound, wherein the particulate carrier is anhydrous sodium sulfate having a mean particle size of from 1 to 40 μm.

17. A process according to claim 16 in which the binder is a waxy material and is solidified by cooling.

18. A process according to claim 16 in which the binder is a solution or emulsion of a polymer and is solidified by drying the treated particulate carrier.

19. A process according to claim 16 in which the binder comprises a waxy material and a solution or emulsion of a polymer and is solidified by drying the treated particulate carrier in a gas flow cool enough to solidify the waxy material.

20-21. (canceled)

22. A granulated product according to claim 1, comprising at least 6% by weight organosilicon compound.
